(19) United States
(12) Patent Application Publication
(10) Pub. No.: US 2014/0167337 A1
(43) Pub. Date: Jun. 19, 2014

(54) AIR SPRING PISTON FOR A HEAVY-DUTY VEHICLE

(71) Applicants: Contitech Luftfedersysteme GmbH, Hannover (DE); Hendrickson USA, L.L.C., Itasca, IL (US)

(72) Inventors: John E. Ramsey, Canton, OH (US); Thomas J. Long, Canton, OH (US); Brian R. Anderson, Canton, OH (US); Carsten Hansen, Piene (DE); Mohamad Taghizadeh Mershon, Indianapolis, IN (US); Gregory A. Richardson, Nixa, MO (US); Armando Vazquez Fernandez, San Luis Potosi (MX)

(73) Assignees: Contitech Luftfedersysteme GmbH, Hannover (DE); Hendrickson USA, L.L.C., Itasca, IL (US)

(21) Appl. No.: 14/103,963

(22) Filed: Dec. 12, 2013

Related U.S. Application Data
(60) Provisional application No. 61/736,593, filed on Dec. 13, 2012.

(51) Int. Cl. F16F 9/05; F16F 9/32

(52) U.S. Cl. CPC F16F 9/057; F16F 9/3214
USPC 267/124

(57) ABSTRACT

An air spring piston for a heavy-duty vehicle includes a top portion and a bottom portion. The top portion includes a bumper and a connecting means for an air spring bellows. The bottom portion is mounted on a structure of the vehicle. The top portion and bottom portion are connected to each other to form a piston chamber and include a bearing means for reacting bumper forces from the bumper to the bottom portion and to the structure of the vehicle on which the bottom portion is mounted. The piston chamber is in fluid communication with a bellows chamber of the air spring via an opening, wherein the geometry of the opening is such that during dynamic spring movements, the pressure in the piston chamber and the pressure in the bellows chamber are not equalized.

### CROSS-REFERENCE TO RELATED APPLICATION

This application claims the benefit of U.S. Provisional Patent Application Ser. No. 61/736,593, filed Dec. 13, 2012.

### BACKGROUND OF THE INVENTION

1. Field of the Invention

The invention relates generally to the art of axle/suspension systems for heavy-duty vehicles. More particularly, the invention relates to air-ride axle/suspension systems for heavy-duty vehicles, which utilize an air spring to cushion the ride of the vehicle. More specifically, the invention is directed to a piston for an air spring of a heavy-duty vehicle air-ride axle/suspension system, in which the air spring piston is formed of at least two parts, an upper portion and a lower portion, that cooperate with one another to form an enclosed piston chamber volume. Both the upper portion and the lower portion of the air spring piston include a bearing means to react bump forces from the bumper situated on the upper portion of the air spring piston to the mounting area of the lower portion of the air spring piston. The enclosed volume of the air spring piston is continuous with the enclosed volume of the air spring bellows via at least one opening, wherein the geometry of the opening is such that during dynamic spring movements the pressure in both interconnected volumes will not be equalized, thereby providing improved damping characteristics to the air spring.

2. Background Art

The use of air-ride trailing and leading arm rigid beam-type axle/suspension systems has been popular in the heavy-duty truck and tractor-trailer industry for many years. Although such axle/suspension systems can be found in widely varying structural forms, in general their structure is similar in that each system typically includes a pair of suspension assemblies. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, or secondary slider frame. For the purpose of convenience and clarity, reference herein will be made to main members, with the understanding that such reference is by way of example, and that the present invention applies to heavy-duty vehicle axle/suspension systems suspended from main members of: primary frames, movable subframes and non-movable subframes.

Specifically, each suspension assembly of an axle/suspension system includes a longitudinally extending elongated beam. Each beam typically is located adjacent to and below a respective one of a pair of spaced-apart longitudinally extending main members and one or more cross members, which form the frame of the vehicle. More specifically, each beam is pivotally connected at one of its ends to a hanger, which in turn is attached to and depends from a respective one of the main members of the vehicle. An axle extends transversely between and typically is connected by some means to the beams of the pair of suspension assemblies at a selected location from about the mid-point of each beam to the end of the beam opposite from its pivotal connection end. The opposite end of each beam also is connected to an air spring, or its equivalent, which in turn is connected to a respective one of the main members. A height control valve is mounted on the hanger or other support structure and is operatively connected to the beam and to the air spring in order to maintain the ride height of the vehicle. A brake system and one or more shock absorbers for providing damping to the vehicle axle/suspension system are also included. The beam may extend rearwardly or frontwardly from the pivotal connection relative to the front of the vehicle, thus defining what are typically referred to as trailing arm or leading arm axle/suspension systems, respectively. However, for purposes of the description contained herein, it is understood that the term “trailing arm” will encompass beams, which extend either rearwardly or frontwardly with respect to the front end of the vehicle.

The axle/suspension systems of the heavy-duty vehicle act to cushion the ride, dampen vibrations and stabilize the vehicle. More particularly, as the vehicle is traveling over the road, its wheels encounter road conditions that impart various forces, loads, and/or stresses, collectively referred to herein as forces, to the respective axle on which the wheels are mounted, and in turn, to the suspension assemblies that are connected to and support the axle. In order to minimize the detrimental effect of these forces on the vehicle and/or its cargo as it is operating, the axle/suspension system is designed to react and/or absorb at least some of them.

These forces include vertical forces caused by vertical movement of the wheels as they encounter certain road conditions, fore-aft forces caused by acceleration and deceleration of the vehicle due to operation of the vehicle and/or road conditions, and side-load and torsional forces associated with transverse vehicle movement, such as turning of the vehicle and lane-change maneuvers. In order to address such disparate forces, axle/suspension systems have differing structural requirements. More particularly, it is desirable for an axle/suspension system to minimize the amount of sway experienced by the vehicle and thus provide what is known in the art as roll stability. However, it is also desirable for an axle/suspension system to be relatively flexible to assist in cushioning the vehicle from vertical impacts, and to provide compliance so that the components of the axle/suspension system resist failure, thereby increasing durability of the axle/suspension system. It is also desirable to dampen the vibrations or oscillations that result from such forces in order to reduce wheel and/or suspension bounce, which in turn can potentially harm the wheels and the components of the axle/suspension system, thereby reducing optimal ride characteristics of the axle/suspension system. A key component of the axle/suspension system that cushions the ride of the vehicle from vertical impacts is the air spring or other spring mechanism, such as a coil spring or a leaf spring, while a shock absorber typically provides damping to the axle/suspension system.

The typical air spring of the type utilized in heavy-duty air-ride axle/suspension systems includes three main components: a flexible bellows, a bellows top plate and a piston. The bellows is typically formed from rubber or other flexible material, and is sealingly engaged with the bellows top plate and also to the top portion of the piston. The volume of pressurized air, or “air volume”, that is contained within the air spring is a major factor in determining the spring rate of the air spring. More specifically, this air volume is contained within the bellows and, in some cases, the piston of the air spring. Usually, the larger the air volume of the air spring, the lower the spring rate of the air spring. A lower spring rate is generally more desirable in the heavy-duty vehicle industry because it allows for softer ride characteristics for the vehicle. Typically, the piston either contains a hollow cavity, which is in communication with the bellows and which adds to the air volume of the air spring by allowing unrestricted communication of air between the piston and the bellows volumes, or the piston has a generally hollow cylindrical-shape and does not communicate with the bellows volume, whereby the piston does not contribute to the air volume of the air spring. In any event, the air volume of the air spring is in fluid communication with an air source, such as an air supply tank, and also is in fluid communication with the height control valve of the vehicle. The height control valve, by directing air flow into and out of the air spring of the axle/suspension system, helps maintain the desired ride height of the vehicle.

Prior art air spring pistons are generally cylindrical shaped and include a continuous generally stepped sidewall attached to a generally flat bottom plate. A top plate is formed at the top of the piston. The bottom plate is formed with an upwardly extending central hub. The central hub includes a bottom plate formed with one or more central openings. A fastener is disposed through the openings in the central hub bottom plate in order to attach the piston to the beam of the suspension assembly at its rear end. The top plate, sidewall and bottom plate of the piston define a piston chamber having an interior volume. The top plate of the piston is formed with a circular upwardly extending protrusion having a lip or barb around its circumference. The barb cooperates with the lowermost end of the air spring bellows to form an airtight seal between the bellows and the piston. A bumper is attached to a bumper mounting plate, which is in turn mounted on the piston top plate by a fastener. The bumper extends upwardly from the top surface of the bumper mounting plate and serves as a cushion between the piston top plate and the bellows top plate in order to cushion contact between the two plates during operation of the vehicle. The piston is typically formed from steel, aluminum, fiber reinforced plastic or other rigid material.

Because the prior art air spring piston described above may have a relatively complex multi-piece structural design, manufacture of the piston from composite materials is not feasible. Moreover, prior art composite air spring piston designs of the enclosed volume variety generally do not provide sufficient bumper force support to optimally react bumper forces during operation of the air spring, which can potentially lead to failure of the air spring piston and or components of the axle/suspension system. Furthermore, some prior art air spring piston designs do not provide damping characteristics so that the use of a shock absorber is required to provide damping to the axle/suspension system.

The air spring piston for heavy-duty vehicles of the present invention, overcomes the problems associated with prior art air spring piston designs by providing an air spring piston formed in two composite parts that are friction welded together. The air spring piston for heavy-duty vehicles of the present invention may optionally include two enclosed volumes that are interconnected by at least one opening such that during dynamic movements of the air spring, the pressure in both interconnected enclosed volumes of the piston will be nearly equal and act as one common volume. The two-piece air spring piston design includes at least one opening that provides fluid communication between the common piston volumes and the air spring bellows volume, so that during dynamic spring movements of the air spring the pressure in both volumes is generally not equalized. Damping is primarily provided by the movement of air through the opening located between the air spring piston chamber and the air spring bellows chamber. In addition, the air spring piston for heavy-duty vehicles of the present invention includes a top plate and a bottom plate that are rigid and not hydraulically active and therefore will not generally influence the exchange of fluid between the air spring bellows chamber and the air spring piston chamber. Furthermore, the air spring piston for heavy-duty vehicles of the present invention includes a bearing means for reacting bumper forces during operation of the air spring that includes a plurality of tube-like support structures that extend generally from the bottom plate to the top plate of the air spring piston. The air spring piston for heavy-duty vehicles of the present invention provides improved damping characteristics and improved reaction of bumper forces during operation of the air spring.

### SUMMARY OF THE INVENTION

Objectives of the present invention include providing a piston for an air spring of a heavy-duty vehicle that provides improved damping to the air spring during operation of the vehicle.

A further objective of the present invention is to provide a piston for an air spring of a heavy-duty vehicle that does not contain mechanisms that will influence the exchange of fluid between the air spring bellows chamber and the air spring piston chamber other than the openings.

Yet another objective of the present invention is to provide a piston for an air spring of a heavy-duty vehicle that reacts bumper forces during operation of the vehicle.

These objectives and advantages are obtained by the piston for an air spring of a vehicle which includes a top portion including a connecting means for an air spring bellows. A bottom portion mounted on a structure of the vehicle. The top portion and the bottom portion being connected to each other to form a piston chamber. The top and bottom portions including bearing means interlocking with one another for reacting bumper forces from a bumper of the air spring to the top and bottom portions and to the structure of the vehicle. The piston chamber being in fluid communication with a bellows chamber of the air spring via an opening, wherein a geometry of the opening restricts equalization of a pressure in the piston chamber and a pressure in the bellows chamber during dynamic air spring movements during operation of the vehicle.

### BRIEF DESCRIPTION OF THE SEVERAL VIEWS OF THE DRAWINGS

The preferred embodiments of the present invention, illustrative of the best mode in which applicants have contemplated applying the principles, are set forth in the following description and are shown in the drawings, and are particularly and distinctly pointed out and set forth in the appended claims.

FIG. 1 is a top rear perspective view of an air-ride trailing arm heavy-duty trailer axle/suspension system incorporating a pair of prior art air springs, with each one of the pair of air springs mounted on a respective one of the suspension assemblies of the axle/suspension system;

FIG. 2 is a perspective view of a prior art air spring in section, showing the circular upwardly-extending protrusion and lip or barb integrally formed as one-piece with the piston top plate, and showing the generally flat piston bottom plate and flat central hub bottom plate;

FIG. 2A is a front perspective view of the beam of the driver side suspension assembly shown in FIG. 1, showing a beam mounting pedestal attached to the top plate of the beam for mounting the air spring on the suspension assembly;

FIG. 2B is a sectional perspective view of a prior art air spring for a truck axle/suspension system, showing the upwardly-extending protrusion and lip or barb integrally formed as one-piece and showing the generally flat bottom plate of the piston;

FIG. 2C is a fragmentary sectional elevational view of another prior art air spring for a heavy-duty trailer, showing the air spring piston mounted on a conventional beam mounting pedestal and beam of the axle/suspension system;

FIG. 3 is a top view of a first preferred embodiment air spring piston for heavy-duty vehicles of the present invention, showing the top portion of the air spring piston with the bumper removed and formed with a pair of openings that provide fluid communication between the enclosed volume of the air spring piston chamber and the air spring bellows chamber;

FIG. 4 is a bottom view of the first preferred embodiment air spring piston for heavy-duty vehicles of the present invention, showing the bottom portion of the air spring piston;

FIG. 5 is a sectional view of the first preferred embodiment air spring piston for heavy-duty vehicles taken along lines AA in FIG. 4, showing the two-piece construction of the air spring piston and showing the concentrically arranged intermediate column and central hub, the opening formed in the top plate and the opening formed in the separate enclosed volumes of the air spring piston;

FIG. 5A is a view similar to FIG. 5, showing the bellows and the bellows top plate mounted on the first preferred embodiment air spring piston for heavy-duty vehicles of the present invention, and showing the bellows chamber;

FIG. 6 is a sectional view of the first preferred embodiment air spring piston for heavy-duty vehicles taken along lines BB in FIG. 4, showing the two-piece construction of the air spring piston and showing the concentrically arranged intermediate column and central hub;

FIG. 7 is a greatly enlarged fragmentary view of a portion of the first preferred embodiment air spring piston for heavy-duty vehicles of the present invention shown in FIG. 5, and showing the correspondingly shaped grooves and crests formed in the top and bottom portions, respectively, of the air spring piston for friction welding the two portions of the air spring, piston together;

FIG. 8 is a greatly enlarged fragmentary sectional view taken along lines CC in FIG. 7, showing the opening formed between the two enclosed volumes of the first preferred embodiment air spring piston;

FIG. 9 is a greatly enlarged fragmentary sectional view of a portion of the first preferred embodiment air spring piston for heavy-duty vehicles of the present invention, showing a portion of the top plate protrusion including the lip or barb;

FIG. 10 is a sectional view of a second preferred embodiment air spring piston for heavy-duty vehicles of the present invention, showing the two-piece construction of the air spring piston, showing the concentrically arranged intermediate column and central hub, and showing the opening formed in the separate enclosed volumes of the air spring piston; and

FIG. 11 is a view similar to FIG. 5, showing the bellows and the bellows top plate mounted on the second preferred embodiment air spring piston for heavy-duty vehicles of the present invention, and showing the bellows chamber.

Similar numerals refer to similar parts throughout the drawings.

### DESCRIPTION OF THE PREFERRED EMBODIMENTS

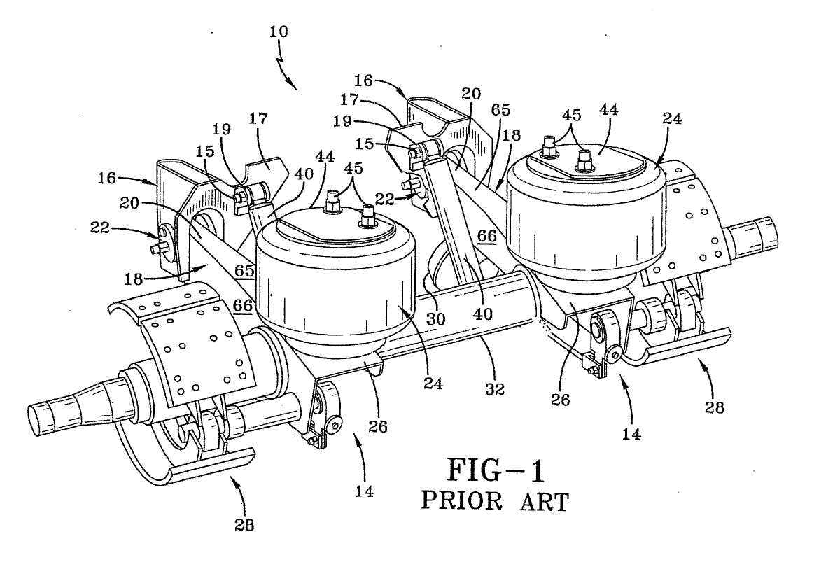

In order to better understand the environment in which the air spring piston for heavy-duty vehicles of the present invention is utilized, a trailing arm overslung beam-type air-ride axle/suspension system that incorporates a prior art heavy-duty vehicle trailer air spring 24, is indicated generally at 10, is shown in FIG. 1, and now will be described in detail below.

It should be noted that axle/suspension system 10 is typically mounted on a pair of longitudinally-extending spaced-apart main members (not shown) of a heavy-duty vehicle, which is generally representative of various types of frames used for heavy-duty vehicles, including primary frames that do not support a subframe and primary frames and/or floor structures that do support a subframe. For primary frames and/or floor structures that do support a subframe, the subframe can be non-movable or movable, the latter being commonly referred to as a slider box. Because axle/suspension system 10 generally includes an identical pair of suspension assemblies 14, for sake of clarity only one of the suspension assemblies will be described below.

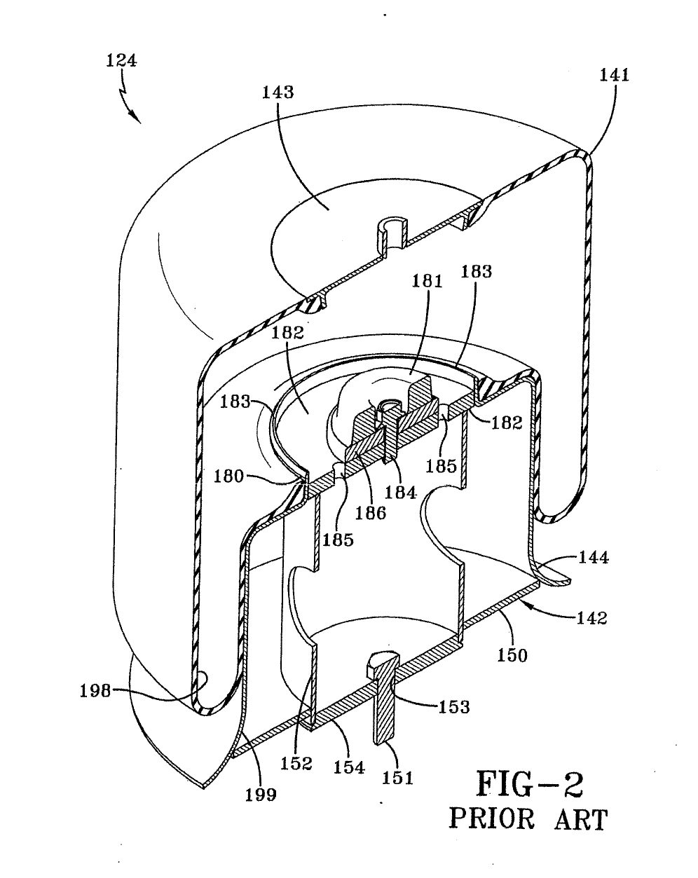

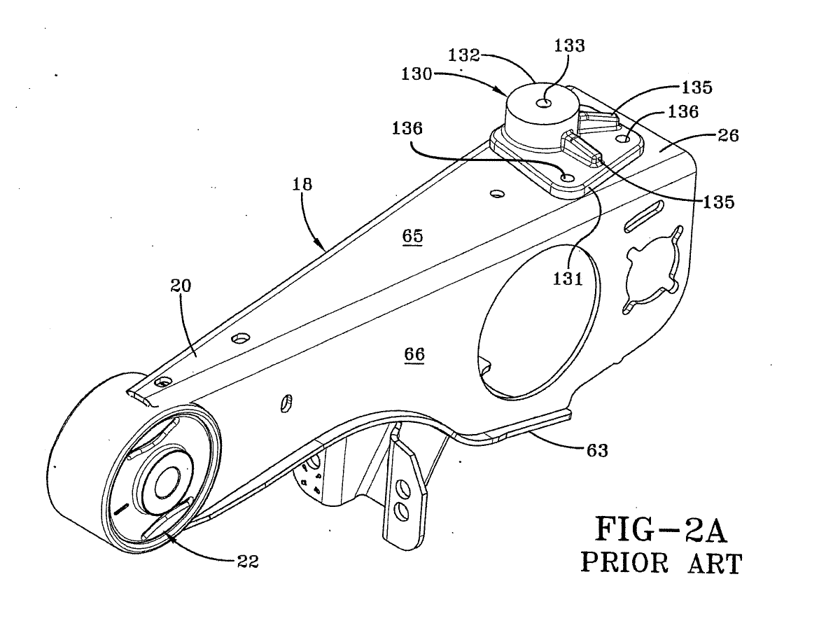

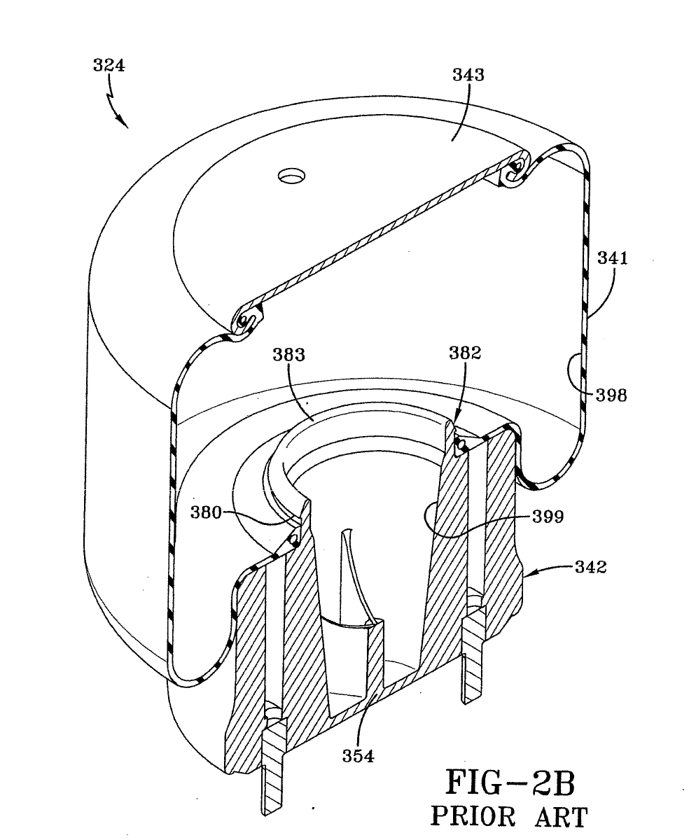

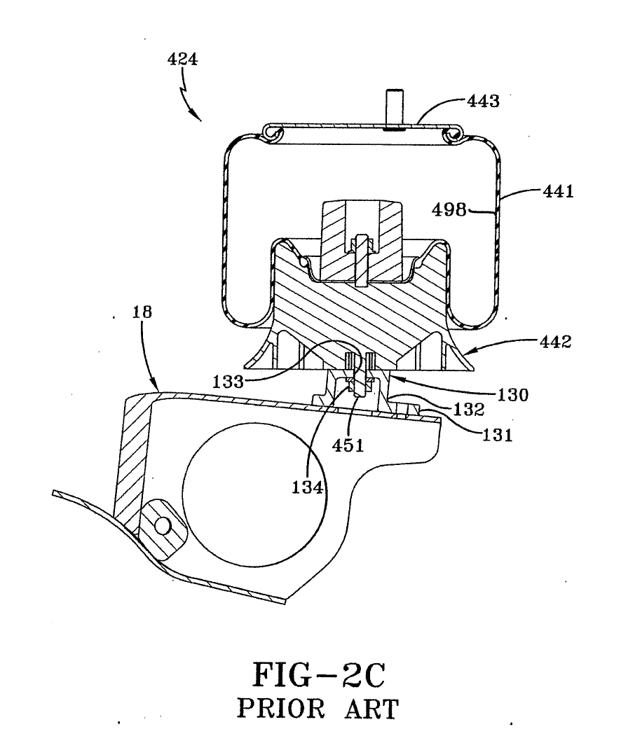

Suspension assembly 14 is pivotally connected to a hanger 16 via a trailing arm overslung beam 18. More specifically, beam 18 is formed having a generally upside-down integrally formed U-shape with a pair of sidewalls 66 and a top plate 65, with the open portion of the beam facing generally downwardly. A bottom plate 63 (FIG. 2A) extends between and is attached to the lowermost ends of sidewalls 66 by any suitable means such as welding to complete the structure of beam 18. Trailing arm overslung beam 18 includes a front end 20 having a bushing assembly 22, which includes a bushing, pivot bolts and washers as are well known in the art, to facilitate pivotal connection of the beam to hanger 16. Beam 18 also includes a rear end 26, which is welded or otherwise rigidly attached to a transversely extending axle 32.

Suspension assembly 14 also includes a shock absorber 40 having its top end mounted on an inboardly extending wing 17 of hanger 16 via a mounting bracket 19 and a fastener 15, in a manner well known in the art. The bottom end of shock absorber 40 is mounted to beam 18 (the mount not shown) in a manner well known to those having skill in the art. For the sake of relative completeness, a brake system 28 including a brake chamber 30 is shown mounted on prior art suspension assembly 14.

As mentioned above, axle/suspension system 10 is designed to absorb forces that act on the vehicle as it is operating. More particularly, it is desirable for axle/suspension system 10 to resist roll forces and thus provide roll stability for the vehicle. This is typically accomplished by using beam 18, which is rigid, and is rigidly attached to axle 32. It is also desirable, however, for axle/suspension system 10 to be flexible to assist in cushioning the vehicle (not shown) from vertical impacts and to provide compliance so that the axle/suspension system resists failure. Such flexibility typically is achieved through the pivotal connection of beam 18 to hanger 16 with bushing assembly 22. Air spring 24 and shock absorber 40 also assist in cushioning the ride for cargo and/or passengers.

More specifically, prior art air spring 24 shown in FIG. 1 is an air spring of the non-damping type similar to air spring 424 shown in FIG. 2C that utilizes shock absorbers 40 to provide damping to the axle/suspension system, which will be described in detail below. Air spring 24 could also be an air spring of the damping type, such as air spring 124 shown in FIG. 2, which is typically used without shock absorbers 40, and which now will be described in detail below. Air spring 124 is typically incorporated into an axle/suspension system such as axle/suspension system 10, or other similar air-ride axle/suspension system. Air spring 124 includes a bellows 141, a bellows top plate 143 and a piston 142. The top end of bellows 141 is sealingly engaged with bellows top plate 143 in a manner well known in the art. An air spring mounting plate 44 (FIG. 1) is typically mounted on the top surface of top plate 143 by fasteners 45 which are also used to mount the top portion of air spring 124 to a respective one of the main members (not shown) of the vehicle. Alternatively, bellows top plate 143 could also be mounted directly on a respective one of the main members (not shown) of the vehicle. Piston 142 is generally cylindrical-shaped and includes a continuous generally stepped sidewall 144 attached to a generally flat bottom plate 150 and integrally formed in one piece with a top plate 182. Bottom plate 150 is formed with an upwardly extending central hub 152 and is attached to sidewall 144 in a well-known manner. Central hub 152 includes a bottom plate 154 formed with a central opening 153. A fastener 151 is disposed through opening 153 in order to attach piston 142 to a beam mounting pedestal 130 (FIG. 2A), of a type that is well known in the beam-air spring mounting art.

With additional reference to FIG. 2A, beam mounting pedestal 130 includes a generally flat base 131 for contacting and seating on beam top plate 65 at beam rear end 26. Beam mounting pedestal 130 also includes an upwardly extending column 132, which contacts central hub bottom plate 154 of air spring piston 142. Column 132 is formed with a central generally vertically extending opening 133, through which fastener 151 is disposed. A lock nut 134 (FIG. 2C) is threaded onto a threaded end of fastener 151 in order to attach piston 142 to beam mounting pedestal 130. A pair of strengthening webs 135 are located on column 132 and extend outwardly from the column on flat base 131. A pair of openings 136 are formed in pedestal base 131. Each one of openings 136 receive a fastener (not shown) for attaching pedestal 130 to beam top plate 65 at beam rear end 26. Beam mounting pedestal 130 is typically formed from a rigid material such as steel, aluminum or composite material, as is well known in the art, and may or may not include strengthening webs 135.

With continued reference to FIG. 2, top plate 182, sidewall 144 and bottom plate 150 of piston 142 define a piston chamber 199. Top plate 182 of piston 142 is formed with a circular upwardly extending protrusion 183 having a lip or barb 180 around its circumference. Barb 180 cooperates with the bottom terminal end of bellows 141 to form an airtight seal between the bellows and the barb around the circumference of protrusion 183 of piston 142, as is well known to those of ordinary skill in the art. Bellows 141, top plate 143 and piston top plate 182 define a bellows chamber 198. A bumper 181 is rigidly attached to a bumper mounting plate 186 by means generally well known in the art. Bumper mounting plate 186 is in turn mounted on piston top plate 182 by a fastener 184. Bumper 181 extends upwardly from the top surface of bumper mounting plate 186. Bumper 181 serves as a cushion between piston top plate 182 and the underside of bellows top plate 143 in order to prevent the plates from damaging one another in the event that the piston top plate and the underside of the bellows top plate contact one another during operation of the vehicle. Manufacture of piston 142 as an integral one-piece component from composite materials can be quite complicated and therefore inefficient, as is well known to those of ordinary skill in the art. Moreover, the inclusion of a single central hub 152, although sufficient for air spring pistons made from metal, would not provide sufficient bumper support for an air spring piston made from a composite material.

Piston top plate 182 is formed with a pair of openings 185, which allow the volume of piston chamber 199 and the volume of bellows chamber 198 to communicate with one another. More particularly, openings 185 allow fluid or air to pass between piston chamber 199 and bellows chamber 198 during operation of the vehicle.

Turning now to FIG. 2B, a prior art air spring for a truck axle/suspension system is shown generally at 324. Air spring 324 generally includes a bellows 341, a bellows chamber 398, a bellows top plate 343, a piston chamber 399 and a piston 342. Piston 342 is formed with a generally flat bottom plate 354 and an open top plate 382 having an upwardly extending protrusion 383 formed with a lip or barb 380. Hollow piston chamber 399 is in fluid communication with bellows 341 and allows unrestricted communication of air between the piston cavity and the bellows chamber 398. Because prior art air spring piston 342 has an integral one-piece structural design, manufacture of the piston from composite materials can be complicated. Moreover, prior art air spring piston 342 provides no bumper support.

Turning now to FIG. 2C, another example of a prior art air spring for an axle/suspension system is shown generally at 424. Air spring 424 generally includes a bellows 441, a bellows top plate 443 and a piston 442. Piston 442 is mounted on suspension assembly beam 18 by fastener 451 disposed through conventional beam mounting pedestal 130, described in detail above. Air spring 424 is representative of an air spring configuration different from prior art air springs 124 and 324, whereby piston 424 does not contribute to the air volume of the air spring and which still utilizes conventional beam mounting pedestal 130 in the field, i.e. no piston chamber, only a bellows chamber 498.

As set forth above, because prior art air spring pistons 342,442 each have a relatively complex integral one-piece structural design, manufacture of the pistons from a composite material can be complicated. Moreover, prior art air spring pistons 342,442 do not alone provide sufficient damping to the axle/suspension system during operation of the vehicle and, therefore, require the use of a shock absorber. In addition, prior art air spring piston 342 does not provide bumper support. Although prior art air spring piston 142 does provide sufficient bumper support, because it is formed from metal, it is heavy, and manufacture of the air spring from a composite material is not feasible. The air spring piston of the present invention overcomes the problems associated with prior art air spring pistons 142,342,442, and will now be described in detail below.

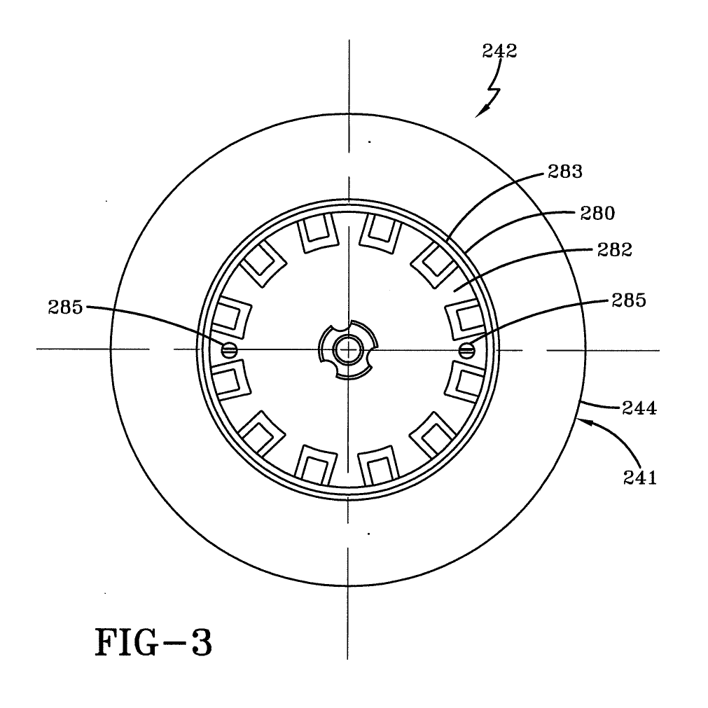

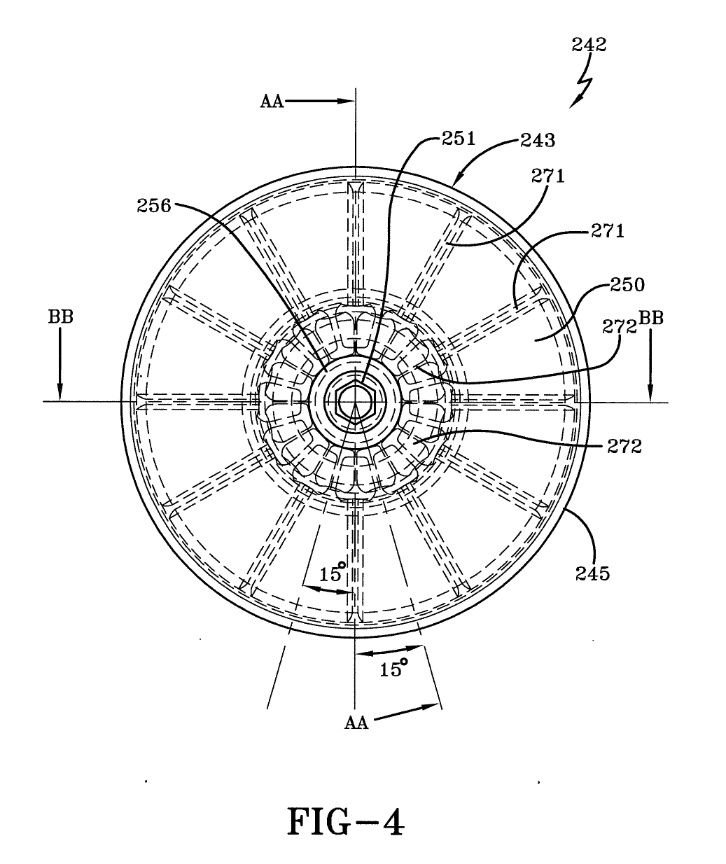

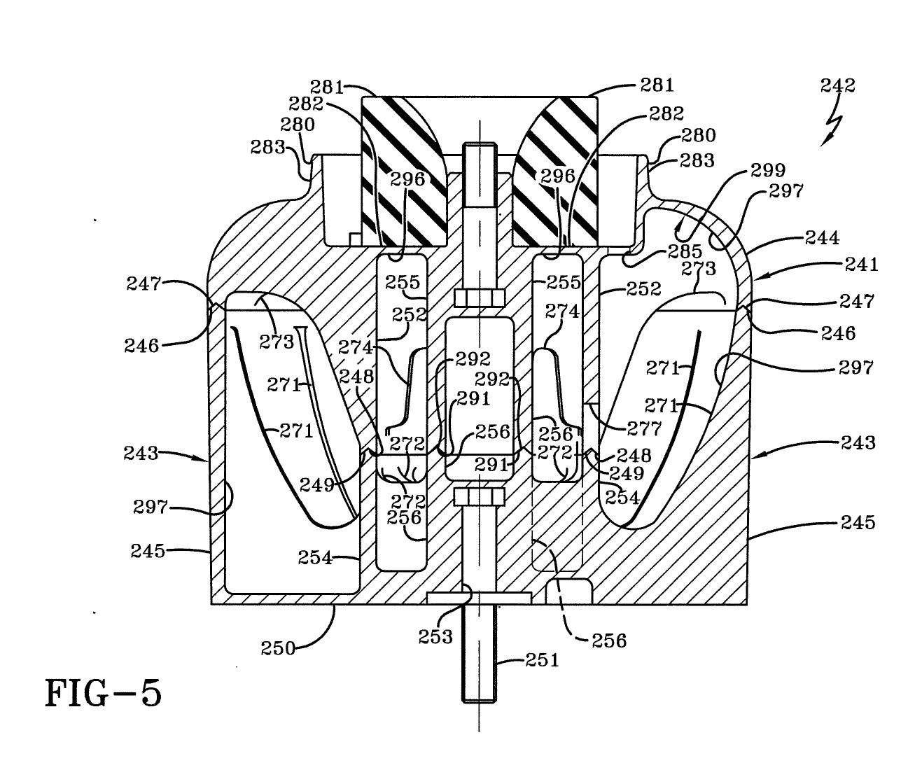

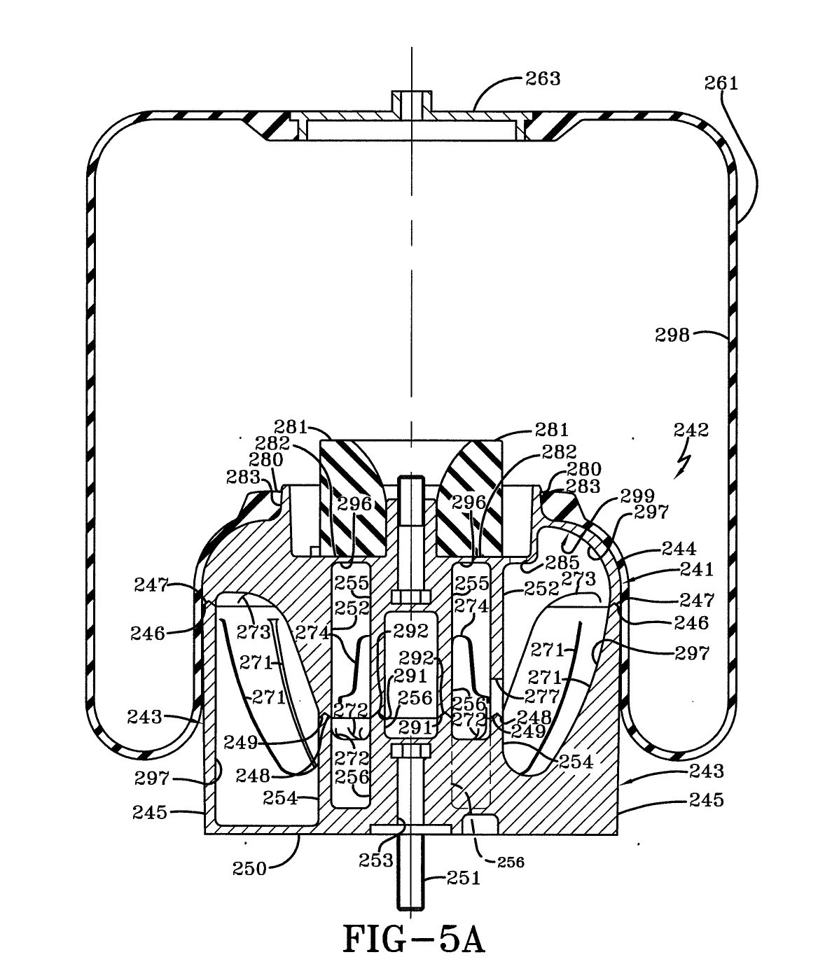

A first preferred embodiment air spring piston of the present invention is shown in FIGS. 3-9, is indicated generally at 242, and now will be described in detail below. First preferred embodiment air spring piston 242 is utilized in conjunction with an air spring which includes a bellows 261 (FIG. 5A), a bellows top plate 263 and the first preferred embodiment air spring piston of the present invention. The top end of the bellows is sealingly engaged with the bellows top plate in a manner well known in the art. An air spring mounting plate (not shown) is mounted on the top surface of the top plate by fasteners (not shown) which are also used to mount the top portion of the air spring to a respective one of the main members (not shown) of the vehicle frame. Alternatively, the bellows top plate could be mounted directly on a respective one of the main members (not shown) of the vehicle.

In accordance with an important feature of the present invention, first preferred embodiment air spring piston 242 is generally cylindrical-shaped, formed of a composite material and includes a top portion 241 and a bottom portion 243. Piston top portion 241 includes a generally stepped sidewall 244, a central hub 255 and a top plate 282. Piston bottom portion 243 is generally cup-shaped and includes a generally flat bottom plate 250, a central hub 256 and a sidewall 245. Piston top portion sidewall 244 extends radially from top plate 282 and engages sidewall 245 of piston bottom portion 243, as will be described in greater detail below.

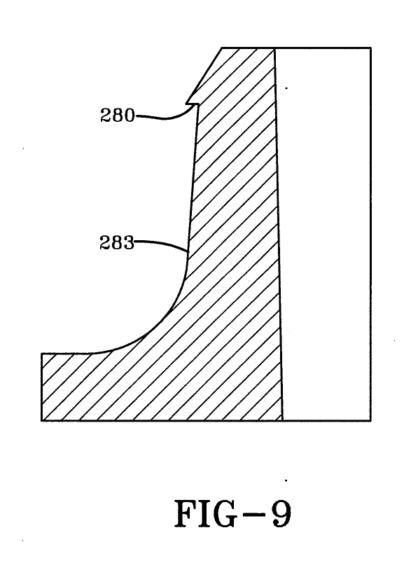

With particular reference to FIGS. 5 and 9, top plate 282 also is formed with a generally circular upwardly extending protrusion 283 formed with a lip or barb 280 around its circumference. Extending protrusion 283 and barb 280 serve as a connecting means for the air spring bellows as set forth below. More particularly, barb 280 cooperates with the bottom terminal end of air spring bellows 241 to form an airtight seal between the bellows and the barb, as is well known to those of ordinary skill in the art.

Piston bottom portion bottom plate 250 is formed with a central opening 253, which is recessed relative to bottom plate 250. A fastener 251 is disposed through opening 253 in order to attach piston 242 to a prior art beam mounting pedestal described above.

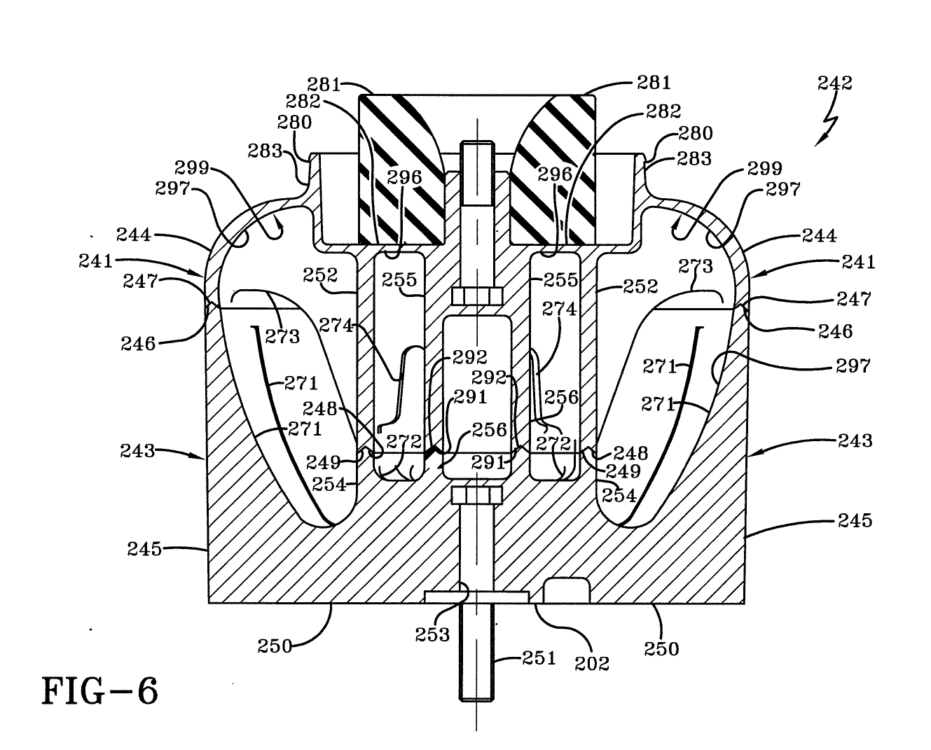

With reference to FIGS. 5 and 6, piston top portion 241 is formed with an intermediate cylindrical column 252 that is spaced concentrically between central hub 255 and sidewall 244. Likewise, piston bottom portion 243 is formed with an intermediate cylindrical column 254 that is spaced concentrically between central hub 256 and sidewall 245. A plurality of ribs 271 extend radially between piston bottom portion sidewall 245 and intermediate column 254. A plurality of ribs 272 extend radially between piston bottom portion intermediate column 254 and central hub 256. A plurality of ribs 273 extend radially between piston top portion sidewall 244 and intermediate column 252. A plurality of ribs 274 extend radially between piston top portion intermediate column 252 and central hub 255.

The lower end of top portion sidewall 244 is formed with a groove 246 (FIGS. 5-7). Groove 246 mates with a correspondingly shaped crest 247 formed on the upper end of sidewall 245 of piston bottom portion 243. Likewise, the lower end of top portion intermediate column 252 is formed with a groove 248. Groove 248 interlocks or mates with correspondingly shaped crest 249 formed on the upper end of piston bottom portion intermediate column 254. In addition, the lower end of top portion central hub 255 is formed with a groove 291. Groove 291 interlocks or mates with correspondingly shaped crest 292 formed on the upper end of piston bottom portion central hub 256. In this manner, grooves 246,248,291 interlock or matingly engage and correspond with crests 247,249,292 respectively, and allow piston bottom portion 243 and piston top portion 241 to be friction welded to one another during assembly of air spring piston 242.

Central hubs 255,256 and/or intermediate columns 252,254, of piston top portion 241 and piston bottom portion 243, respectively, provide a bearing means to sufficiently/optimally react bumper forces from the inside of the air spring to a lower mounting area 202 of the piston bottom portion.

It should be understood that top portion intermediate column 252 and bottom portion intermediate column 254 could also include a small space between the intermediate columns, such as about 0.030 in., so that the intermediate columns are not friction welded to one another during assembly, and yet still mechanically engage one another when under load, and still provide a bearing means to sufficiently react bumper forces from the inside of the air spring to a lower mounting area 202 of piston bottom portion 243.

Likewise, it should also be understood that top portion central hub 255 and bottom portion central hub 256 could also include a small space between the central hubs, such as about 0.030 in., so that the central hubs are not friction welded to one another during assembly, and yet still mechanically engage one another when under load, and still provide a bearing means to sufficiently react bumper forces from the inside of the air spring to a lower mounting area 202 of piston bottom portion 243.

Moreover, is should be understood that both top portion central hub 255 and bottom portion central hub 256, and top portion intermediate column 252 and bottom portion intermediate column 254, could each include a small space between the intermediate columns and the central hubs, such as about 0.030 in., so that the intermediate columns and the central hubs are not friction welded to one another during assembly, and yet still mechanically engage one another when under load, and still provide a bearing means to sufficiently react bumper forces from the inside of the air spring to a lower mounting area 202 of piston bottom portion 243.

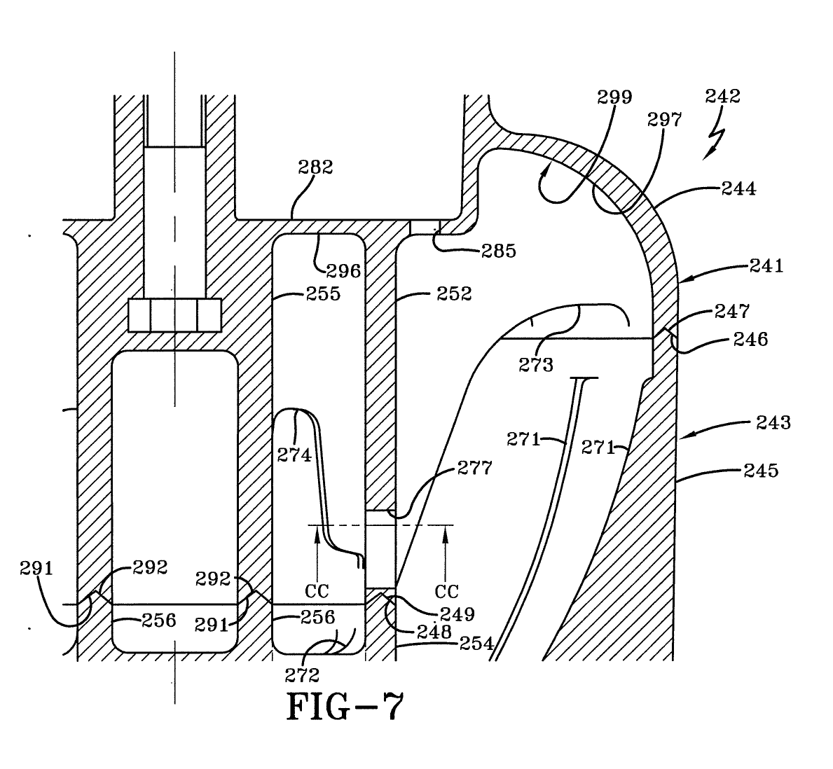

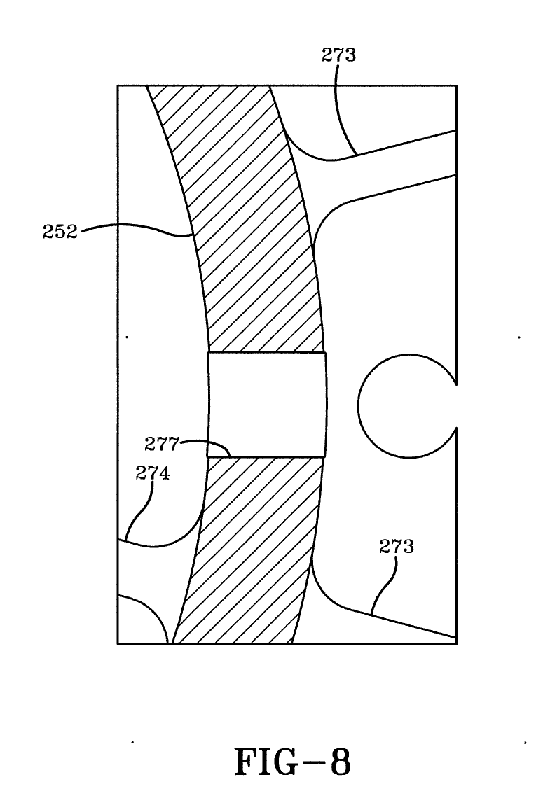

Once assembled, piston top portion 241 and piston bottom portion 243 together form a piston chamber 299. Piston chamber 299 may optionally be divided into two parts, an inner piston chamber 296 and an outer piston chamber 297. Inner piston chamber 296 is in fluid communication with outer piston chamber 297 via an opening 277 formed in piston top portion intermediate column 252, as shown in FIGS. 7 and 8. The shape of opening 277 is such that the pressure in inner piston chamber 296 and outer piston chamber 297 are nearly equal and act as one common volume, during dynamic spring movements at larger amplitudes. It should be understood that opening 277 could also be shaped to provide additional damping to the air spring during dynamic spring movements of the air spring during operation of the vehicle.

Air spring bellows 261, bellows top plate 263 and piston top portion top plate 282 generally form a bellows chamber 298. A bumper 281 is rigidly attached to top plate 282 so that the bumper projects upwardly inside of the air spring bellows. More particularly, bumper 281 extends upwardly from the top surface of piston top portion top plate 282. Bumper 281 serves as a cushion between the top surface of top portion top plate 282 and bellows top plate 263 in order to keep the components from damaging one another in the event that the piston and the bellows top plate contact one another during operation of the vehicle. Moreover, piston top portion 241 and bottom portion 243 are generally rigid with respect to each other and to the air spring and as a result are hydraulically inactive so that the piston top and bottom portions do not generally influence the exchange of fluid between bellows chamber 298 and piston chamber 299 during operation of the vehicle and during dynamic movement of the air spring.

With particular reference to FIGS. 3 and 7, top plate 282 also is formed with a pair of openings 285, which allow the volume of piston chamber 299 and the volume of bellows chamber 298 of the air spring to communicate with one another during operation of the vehicle. More particularly, openings 285 allow fluid or air to pass between piston chamber 299 and bellows chamber 298 during operation of the vehicle. This communication between piston chamber 299 and bellows chamber 298 through openings 285 provides viscous damping to the air spring as described and shown in U.S. Pat. No. 8,540,222, owned by Hendrickson USA, L.L.C. Openings 285 are shaped in such a way so that the pressure in piston chamber 299 and bellows chamber 298 are generally not equalized during dynamic spring movements, most notably at larger amplitudes, during operation of the heavy-duty vehicle, so that maximum damping will be achieved during dynamic spring movements.

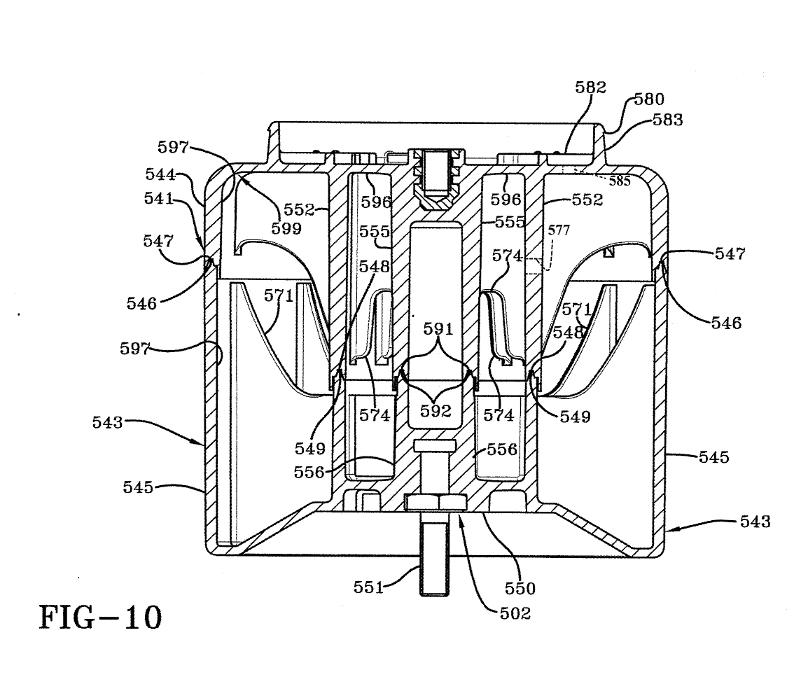

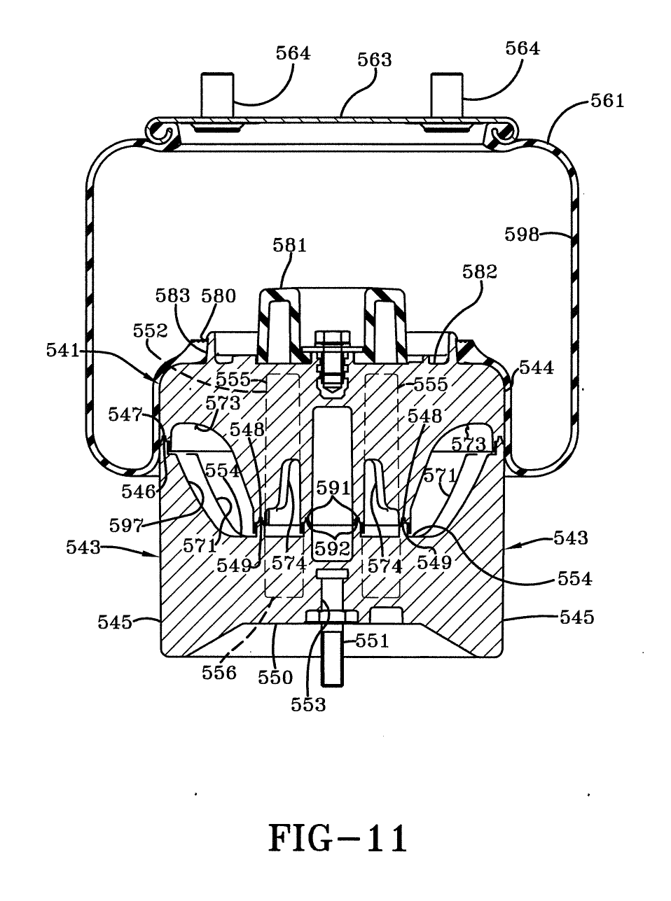

A second preferred embodiment air spring piston of the present invention is shown in FIGS. 10 and 11, is indicated generally at 542, and now will be described in detail below. Second preferred embodiment air spring piston 542 is utilized in conjunction with an air spring which includes a bellows 561 (FIG. 11), a bellows top plate 563 and the second preferred embodiment air spring piston of the present invention. The top end of bellows 561 is sealingly engaged with bellows top plate 563 in a manner well known in the art. An air spring mounting plate (not shown) is mounted on the top surface of top plate 563 by fasteners 564 which are also used to mount the top portion of the air spring to a respective one of the main members (not shown) of the vehicle frame. Alternatively, the bellows top plate could be mounted directly on a respective one of the main members (not shown) of the vehicle. In accordance with an important feature of the present invention, second preferred embodiment air spring piston 542 is generally cylindrical-shaped, formed of a composite material and includes a top portion 541 and a bottom portion 543. Piston top portion 541 includes a generally stepped sidewall 544, a central hub 555 and a top plate 582. Piston bottom portion 543 is generally cup-shaped and includes a generally concave bottom plate 550, a central hub 556 and a sidewall 545. Piston top portion sidewall 544 extends radially from top plate 582 and engages sidewall 545 of piston bottom portion 543, as will be described in greater detail below.

With continued reference to FIGS. 10 and 11, top plate 582 also is formed with a generally circular upwardly extending protrusion 583 formed with a lip or barb 580 around its circumference. Extending protrusion 583 and barb 580 serve as a connecting means for air spring bellows 541 as set forth below. More particularly, barb 580 cooperates with the bottom terminal end of air spring bellows 541 to form an airtight seal between the bellows and the barb, as is well known to those of ordinary skill in the art.

Piston bottom portion bottom plate 550 is formed with a central opening 553, which is recessed relative to bottom plate 550. A fastener 551 is disposed through opening 553 in order to attach piston 542 to a prior art beam mounting pedestal described above.

Piston top portion 541 is formed with an intermediate cylindrical column 552 that is spaced concentrically between central hub 555 and sidewall 544. Likewise, piston bottom portion 543 is formed with an intermediate cylindrical column 554 that is spaced concentrically between central hub 556 and sidewall 545. A plurality of ribs 571 extend radially between piston bottom portion sidewall 545 and intermediate column 554. A plurality of ribs (not shown) extend radially between piston bottom portion intermediate column 554 and central hub 556. A plurality of ribs 573 extend radially between piston top portion sidewall 544 and intermediate column 552. A plurality of ribs 574 extend radially between piston top portion intermediate column 552 and central hub 555.

The lower end of top portion sidewall 544 is formed with a channel 546. Channel 546 interlocks or mates with a correspondingly shaped fin 547 formed on the upper end of sidewall 545 of piston bottom portion 543. Likewise, the lower end of top portion intermediate column 552 is formed with a channel 548. Channel 548 interlocks or mates with correspondingly shaped fin 549 formed on the upper end of piston bottom portion intermediate column 554. In addition, the lower end of top portion central hub 555 is formed with a channel 591. Channel 591 interlocks or mates with correspondingly shaped fin 592 formed on the upper end of piston bottom portion central hub 556. In this manner, channels 546,548,591 matingly engage and correspond with fins 547,549,592 respectively, and allow piston bottom portion 543 and piston top portion 541 to be friction welded to one another during assembly of air spring piston 542.

Central hubs 555,556 and/or intermediate columns 552,554 of piston top portion 541 and piston bottom portion 543, respectively, provide a bearing means to sufficiently/optimally react bumper forces from the inside of the air spring to a lower mounting area 502 of the piston bottom portion.

It should be understood that top portion intermediate column 552 and bottom portion intermediate column 554 could also include a small space between the intermediate columns, such as about 0.030 in., so that the intermediate columns are not friction welded to one another during assembly, and yet still mechanically engage one another when under load, and still provide a bearing means to sufficiently react bumper forces from the inside of the air spring to a lower mounting area 502 of piston bottom portion 543.

Likewise, it should also be understood that top portion central hub 555 and bottom portion central hub 556 could also include a small space between the central hubs, such as about 0.030 in., so that the central hubs are not friction welded to one another during assembly, and yet still mechanically engage one another when under load, and still provide a bearing means to sufficiently react bumper forces from the inside of the air spring to a lower mounting area 502 of piston bottom portion 543.

Moreover, is should be understood that both top portion central hub 555 and bottom portion central hub 556, and top portion intermediate column 552 and bottom portion intermediate column 554, could each include a small space between the intermediate columns and the central hubs, such as about 0.030 in., so that the intermediate columns and the central hubs are not friction welded to one another during assembly, and yet still mechanically engage one another when under load, and still provide a bearing means to sufficiently react bumper forces from the inside of the air spring to a lower mounting area 502 of piston bottom portion 543.

Once assembled, piston top portion 541 and piston bottom portion 543 together form a piston chamber 599. Piston chamber 599 may optionally be divided into two parts, an inner piston chamber 596 and an outer piston chamber 597. Inner piston chamber 596 is in fluid communication with outer piston chamber 597 via an opening 577 formed in piston top portion intermediate column 552. The shape of the opening is such that the pressure in inner piston chamber 596 and outer piston chamber 597 are nearly equal and act as one common volume, during dynamic spring movements at larger amplitudes. It should be understood that opening 577 may also be shaped to provide additional damping to the air spring during dynamic spring movements of the air spring during operation of the vehicle.

Air spring bellows 561, bellows top plate 563 and piston top portion top plate 582 generally form a bellows chamber 598. A bumper 581 is rigidly attached to top plate 582 so that the bumper projects upwardly inside of the air spring bellows. More particularly, bumper 581 extends upwardly from the top surface of piston top portion top plate 582. Bumper 581 serves as a cushion between the top surface of top portion top plate 582 and bellows top plate 563 in order to keep the components from damaging one another in the event that the piston and the bellows top plate contact one another during operation of the vehicle. Moreover, piston top portion 541 and bottom portion 543 are generally hydraulically inactive so that the piston top and bottom portions do not generally influence the exchange of fluid between bellows chamber 598 and piston chamber 599 during operation of the vehicle and during dynamic movement of the air spring.

Top plate 582 also may be formed with a pair of openings 585 (only one shown), which allow the volume of piston chamber 599 and the volume of bellows chamber 598 of the air spring to communicate with one another during operation of the vehicle. More particularly, the openings allow fluid or air to pass between piston chamber 599 and bellows chamber 598 during operation of the vehicle. This communication between piston chamber 599 and bellows chamber 598 through the openings provides viscous damping to the air spring as described and shown in U.S. Pat. No. 8,540,222, owned by Hendrickson USA, L.L.C. The openings are shaped in such a way so that the pressure in piston chamber 599 and bellows chamber 598 are generally not equalized during dynamic spring movements, most notably at larger amplitudes, during operation of the heavy-duty vehicle, so that maximum damping will be achieved during dynamic spring movements.

First and second preferred embodiment air spring pistons 242,542 for heavy-duty vehicles of the present invention overcome the problems associated with prior art air spring pistons 142,342,442 by providing a composite air spring piston, which is formed in two separate parts that are combined. This two-part assembly includes at least one opening 285,585 that provides fluid communication between piston chamber 299,599 and air spring bellows chamber 298,598, respectively, so that during dynamic spring movements of the air spring the pressure in both chambers is not equalized. Moreover, air spring pistons 242,542 for heavy-duty vehicles of the present invention may include at least two enclosed volumes, inner piston chamber 296,596 and outer piston chamber 297,597 that are interconnected by at least one opening 277,577, such that during dynamic spring movements of the air spring at any amplitude, the pressure in both interconnected enclosed volumes of piston chamber 299,599 will be nearly equal and act as one common volume. In addition, air spring pistons 242,542 for heavy-duty vehicles of the present invention include top portions 241,541 and bottom portions 243,543, respectively that are not generally hydraulically active and therefore will generally not influence the exchange of fluid between the air spring bellows and the air spring piston during operation of the vehicle. In other words, top portions 241,541 and bottom portions 243,543 of air spring pistons 242,542, because they are rigid and fixed with respect to one another, will not generally influence the exchange of air between the air spring bellows and the air spring piston during operation of the vehicle. Furthermore, air spring pistons 242,542 for heavy-duty vehicles of the present invention include a bearing means, for sufficiently reacting bumper forces from bumpers 281,581, respectively, during operation of the air spring that includes at least one tube-like support structure that extends from bottom plates 250,550 to top plates 282,582, respectively, of the air spring piston. Air spring pistons 242,542 for heavy-duty vehicles of the present invention provide improved damping characteristics and improved reaction of bumper forces during operation of the air spring.

It is contemplated that preferred embodiment air spring pistons 242,542 of the present invention could be utilized on trucks or tractor-trailers having one or more than one axle without changing the overall concept or operation of the present invention. It is further contemplated that preferred embodiment air spring pistons 242,542 of the present invention could be utilized on vehicles having frames or subframes which are moveable or non-movable without changing the overall concept of the present invention. It is yet even further contemplated that preferred embodiment air spring pistons 242,542 of the present invention could be utilized on all types of air-ride leading and/or trailing arm beam-type axle/suspension system designs known to those skilled in the art without changing the overall concept or operation of the present invention. For example, the present invention finds application with beams or arms that are made of materials other than steel, such as aluminum, other metals, metal alloys, composites, and/or combinations thereof. It is also contemplated that preferred embodiment air spring pistons 242,542 of the present invention could be utilized on axle/suspension systems having either an overslung/top-mount configuration or an underslung/bottom-mount configuration, without changing the overall concept or operation of the present invention. The present invention also finds application in beams or arms with different designs and/or configurations than that shown above, such as solid beams, shell-type beams, truss structures, intersecting plates, spring beams and parallel plates. The present invention also finds application in intermediary structures such as spring seats. It is also contemplated that preferred embodiment air spring pistons 242,542 of the present invention could be utilized in conjunction with other types of air-ride rigid beam-type axle/suspension systems such as those using U-bolts, U-bolt brackets/axle seats and the like, without changing the overall concept or operation of the present invention. It is also contemplated that preferred embodiment air spring pistons 242,542 of the present invention could be formed from various materials, including but not limited to composites, metal and the like, without changing the overall concept or operation of the present invention. It is yet even further contemplated that preferred embodiment air spring pistons 242,542 of the present invention could be utilized with fewer than two or more than two openings 285,585 such as one, three, four or even five or more openings without changing the overall concept for operation of the present invention. It is also contemplated that preferred embodiment air spring pistons 242,542 of the present invention could be utilized with any viscous fluid, such as air or hydraulic fluid, without changing the overall concept of the present invention. It is further contemplated that preferred embodiment air spring pistons 242,542 of the present invention could be utilized in combination with prior art shock absorbers and other similar devices and the like, without changing the overall concept of the present invention. It is contemplated that top plates 282,582 of air spring pistons 242,542 of the present invention could be utilized either with or without bumpers 281,581, without changing the overall concept or operation of the present invention. It is also contemplated that top plate 282,582 of air spring 242,582 of the present invention could be utilized either with or without openings 285,585, without changing the overall concept or operation of the present invention. It is even further contemplated that preferred embodiment air spring pistons 242,542 of the present invention could be utilized in conjunction with prior art pedestal 130 or other similar pedestals or beam mounting structures, without changing the overall concept or operation of the present invention. It is also understood that preferred embodiment air spring pistons 242,542 of the present invention could be utilized with all types of air springs without changing the overall concept or operation of the present invention. It is also contemplated that grooves 246,248,291 and channels 546,548,591 could have different shapes and sizes without changing the overall concept or operation of the invention. It is further contemplated that crests 247,249,292 and fins 547,549,592 could have different shapes and sizes without changing the overall concept or operation of the present invention.

Accordingly, the air spring piston is simplified, provides an effective, safe, inexpensive and efficient structure and method which achieves all the enumerated objectives, provides for eliminating difficulties encountered with prior art air spring pistons, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the air spring piston is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. A piston for an air spring of a vehicle comprising:
a top portion including a connecting means for an air spring bellows;
a bottom portion mounted on a structure of the vehicle;
said top portion and said bottom portion being connected to each other to form a piston chamber, said top and bottom portions including bearing means interlocking with one another for reacting bumper forces from a bumper of said air spring to the top and bottom portions and to said structure of the vehicle; and
said piston chamber being in fluid communication with a bellows chamber of said air spring via an opening, wherein a geometry of said opening restricts equalization of a pressure in said piston chamber and a pressure in said bellows chamber during dynamic air spring movements during operation of said vehicle.

2. The piston for an air spring of a vehicle of claim 1, wherein said opening is designed in a manner such that during dynamic spring movements, damping is generated.

3. The piston for an air spring of a vehicle of claim 1, wherein said opening is designed in a manner such that during dynamic spring movements, a maximum damping is generated at a natural frequency of an axle/suspension system of said vehicle.

4. The piston for an air spring of a vehicle of claim 1, said piston chamber further comprising an inner piston chamber and an outer piston chamber, said inner piston chamber being in fluid communication with said outer piston chamber via an additional opening, wherein a geometry of said additional opening is chosen so that during dynamic spring movements, a pressure of said outer piston chamber and said inner piston chamber are nearly equal and act as a common volume.

5. The piston for an air spring of a vehicle of claim 4, wherein said opening and said additional opening are designed in a manner such that during dynamic spring movements, damping is generated.

6. The piston for an air spring of a vehicle of claim 4, wherein said opening and said additional opening are designed in a manner such that during dynamic spring movements, a maximum damping is generated at a natural frequency of an axle/suspension system of said vehicle.

7. The piston for an air spring of a vehicle of claim 1, wherein said top portion and said bottom portion do not influence the exchange of fluid between said bellows chamber and said piston chamber during dynamic movement of said air spring.

8. The piston for an air spring of a vehicle of claim 1, wherein said top portion and said bottom portion are friction welded to one another.

9. The piston for an air spring of a heavy-duty vehicle of claim 1, said bearing means of said top and bottom portions extending from said top portion to said bottom portion of said piston.

10. The piston for an air spring of a heavy-duty vehicle of claim 1, said top portion bearing means further comprising a groove interlocking with a crest formed on said bottom portion.

11. The piston for an air spring of a heavy-duty vehicle of claim 1, said bearing means further comprising at least one tube-like support.

12. The piston for an air spring of a heavy-duty vehicle of claim 1, said bearing means including more than one tube-like support, said supports being concentrically arranged.

13. The piston for an air spring of a heavy-duty vehicle of claim 12, said outermost tube-like support does not exceed the supporting area from said structure where the bottom portion is mounted.

14. The piston for an air spring of a heavy-duty vehicle of claim 1, said bearing means comprising a central hub extending from said top portion to a central hub extending from said bottom portion.

15. The piston for an air spring of a heavy-duty vehicle of claim 14, said bearing means further comprising an intermediate column extending from said top portion to an intermediate column extending from said bottom portion.

16. The piston for an air spring of a heavy-duty vehicle of claim 14, said top portion central hub and said bottom portion central hub including a gap between them equal to or less than about 0.030 in., said top portion central hub and said bottom portion central hub mechanically engaging one another when under load, and reacting bumper forces.

17. The piston for an air spring of a heavy-duty vehicle of claim 15, said top portion intermediate column and said bottom portion intermediate column including a gap between them equal to or less than about 0.030 in., said top portion intermediate column and said bottom portion intermediate column mechanically engaging one another when under load, and reacting bumper forces.

18. The piston for an air spring of a heavy-duty vehicle of claim 1, wherein said piston is formed from a composite material.

19. The piston for an air spring of a heavy-duty vehicle of claim 1, wherein said bumper is mounted on said top portion of said piston.

20. The piston for an air spring of a heavy-duty vehicle of claim 1, said piston chamber further comprising an inner piston chamber and an outer piston chamber, said inner piston chamber being in fluid communication with said outer piston chamber via an additional opening, wherein a geometry of said additional opening is chosen so that during dynamic spring movements, additional damping is generated in said air spring.
